(19) United States
(12) Patent Application Publication
(10) Pub. No.: US 2010/0250885 A1
(43) Pub. Date: Sep. 30, 2010

(54) STORAGE CONTROL DEVICE, STORAGE SYSTEM, AND COPYING METHOD

(75) Inventor: Yasuyuki Nakata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/749,755

(22) Filed: Mar. 30, 2010

(30) Foreign Application Priority Data
Mar. 31, 2009 (JP) 2009-85980

(51) Int. Cl. G06F 12/16; G06F 12/00

(52) U.S. Cl. 711/162; 711/E12.001; 711/E12.103

(57) ABSTRACT

A storage control device that copies copy source data stored in a copy source volume to a copy destination volume, the storage control device include a copy source data-comparison section configured to compare data transmitted from a host computer to data written into an area specified in the copy source volume storing the transmitted data and a copy function-execution section configured to avoid writing the transmitted data into the copy source volume based on a determination that the data transmitted from the host computer and the data written into the area of the copy destination volume storing the transmitted data that are compared to each other through the copy source data-comparison section agree with each other.

### CROSS-REFERENCE TO RELATED APPLICATIONS

This application is based upon and claims the benefit of priority of the prior Japanese Patent Application No. 2009-85980 filed on Mar. 31, 2009, the entire contents of which are incorporated herein by reference.

### FIELD

This application relates to a storage control device, a storage system, and a copying method.

### BACKGROUND

The One Point Copy (OPC) function is known as a method of generating a backup copy of data of a copy source volume in a storage system and/or a computer. The OPC function is provided to generate a snapshot of data to be backed up, where the snapshot is data that is generated at specified time and that does not reflect updating or the like performed after the specified time. The OPC function, which is performed to generate a backup copy, is provided to back up the entire data of a target copy source volume at the backup-copy generation time.

For example, upon receiving an instruction to perform the OPC function, the instruction being transmitted from a user, a storage system configured to perform the OPC function makes a copy of the entire data of a copy source volume obtained at the OPC instruction-reception time.

The storage system stores data which is the copy of the data of the copy source volume, that is, backup copy data in the copy source volume as a snapshot obtained at the OPC instruction-reception time.

In one specific example, the storage system stores backup copy data which is a copy of the entire data of the copy source volume in association with data of the OPC instruction-reception time and/or the file generation, that is, session information.

Further, as one of expanded functions of the above-described OPC function, the SnapOPC function is known. The SnapOPC function, which is performed to make a backup copy, is a method provided to make a backup copy of only un-updated data of data of the copy source volume, where the un-updated data had been obtained at a location where updating was performed.

For example, upon receiving a SnapOPC instruction to perform the SnapOPC function, the storage system configured to perform the SnapOPC function allocates a specified storage area in association with the SnapOPC instruction-reception time and/or the file generation.

Then, when the copy source volume is updated after the SnapOPC instruction is transmitted to the storage system, a copy of un-updated data that was obtained at a location where the updating is performed, that is, only difference data which is lost from the copy source volume due to the updating is made and stored in the above-described storage area.

Here, one of methods of storing the difference data is disclosed in Japanese Laid-open Patent Publication No. 2005-292865.

### SUMMARY

According to an aspect of the disclosed embodiments, a storage control device that copies copy source data stored in a copy source volume to a copy destination volume includes a copy source data-comparison section configured to compare data transmitted from a host computer to data written into an area specified in the copy source volume storing the transmitted data, and a copy function-execution section configured to avoid writing the transmitted data into the copy source volume based on a determination that the data transmitted from the host computer and the data written into the area of the copy destination volume storing the transmitted data that are compared to each other through the copy source data-comparison section agree with each other.

The object and advantages of the disclosed embodiments will be realized and attained by means of the elements and combinations particularly pointed out in the claims.

It is to be understood that both the foregoing general description and the following detailed description are exemplary and explanatory and are not restrictive of the disclosed embodiments, as claimed.

### BRIEF DESCRIPTION OF DRAWINGS

FIG. 1 illustrates an exemplary hardware configuration of a storage system;

FIG. 2 illustrates an exemplary firmware configuration of a storage control device;

FIG. 3 illustrates an exemplary conceptual diagram of the SnapOPC function;

FIG. 4 illustrates an exemplary conceptual diagram illustrating a write request transmitted from a host computer to the storage system;

FIG. 5 illustrates an exemplary conceptual diagram illustrating how data is written into a temporary buffer and how a response is transmitted to the host computer;

FIG. 6 illustrates an exemplary conceptual diagram illustrating a comparison of a written data item and a data item of a copy source volume;

FIG. 7 illustrates an exemplary conceptual diagram illustrating that processing is terminated when the data items agree with each other;

FIG. 8 illustrates an exemplary conceptual diagram illustrating how written data is copied to a copy destination volume when the compared data items do not agree with each other;

FIG. 9 illustrates an exemplary conceptual diagram illustrating that processing is terminated when compared data items do not agree with each other;

FIG. 10 illustrates an exemplary conceptual diagram illustrating another write request transmitted from the host computer to the storage system;

FIG. 11 illustrates an exemplary conceptual diagram illustrating data writing and how response data is transmitted to the host computer;

FIG. 12 illustrates a conceptual diagram illustrating a comparison of written data and data of the copy destination volume;

FIG. 13 illustrates an exemplary conceptual diagram illustrating that an unallocated area is determined and processing is terminated when data items are compared and agree with each other;

FIG. 14 illustrates an exemplary conceptual diagram illustrating that processing is terminated when data items are compared and do not agree with each other;

FIG. 15 illustrates logical bitmap data;

FIG. 16 illustrates physical bitmap data;

FIG. 17 illustrates LBA conversion table data;

FIG. 18 illustrates an exemplary conceptual diagram illustrating SDV;

FIG. 19 illustrates management table data in transition;

FIG. 20 illustrates a flowchart of a method of comparing data items at the data writing time;

FIG. 21 illustrates an exemplary firmware configuration of another storage control device; and

FIG. 22 illustrates a flowchart of a method for making a check of internal data on a regular basis.

### DESCRIPTION OF EMBODIMENTS

According to the above-described known technologies, an inefficient copy operation is performed as described below.

For performing the SnapOPC function, when the data of a copy source volume is updated after an instruction to perform the SnapOPC function is received, for example, a copy of only data stored in a position where the updating is performed is made and stored in an allocated and specified storage area and the details of the data itself are not checked.

Therefore, if the same data as that of the copy source volume is written into the copy source volume to update the copy source volume (for example, when a host computer performs overwrite copying for file data of the copy source volume), a copy of redundant data is unnecessarily made.

Hereinafter, a storage control device, a storage system, and a copying method according to each of embodiments of the present invention will be described in detail with reference to the attached drawings.

### First Embodiment

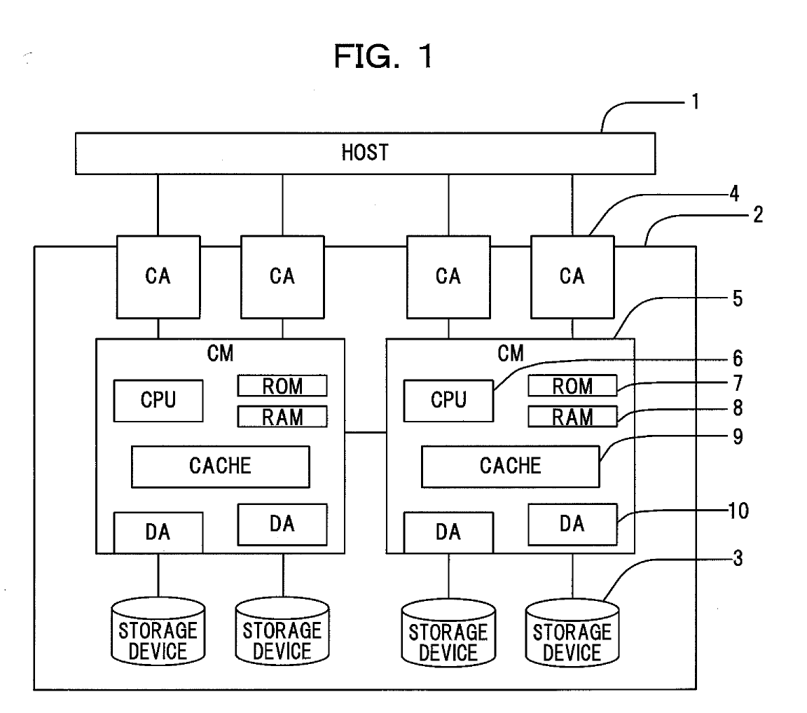

An exemplary hardware configuration of the above-described system will be described with reference to FIG. 1. It is to be noted that the same components will be designated by the same reference numerals throughout all of the drawings. The system includes a host computer 1 and a storage system 2 including a storage device 3, a channel adapter 4, and a controller module (CM) 5. The storage device 3 is a data storage device including a hard disk drive (HDD), a solid state drive (SSD), and so forth. The controller module 5 is the storage control device including a central processing unit (CPU) 6, a nonvolatile memory 7 including a read only memory (ROM), a volatile memory 8 including a random access memory (RAM), a cache memory 9, and a device adapter 10. The volatile memory 8 stores control data including management table data or the like. The cache memory 9 stores user data. The volatile memory 8 and the cache memory 9 may be equivalent to each other. The device adapter 10 is provided as an interface control device provided between the controller module 5 and the storage device 3.

The storage control device is connected to the host computer 1 used by an operator and/or a user, the channel adapter 4 functioning as an interface control device provided between the host computer 1 and the storage system 2, and the data storage device storing data transmitted from the host computer 1. In the data storage device, a copy source volume functioning as a volume storing data to be copied when performing copying and/or making backup copies, and a copy destination volume functioning as a volume provided at the copy destination to store data to be copied are generated.

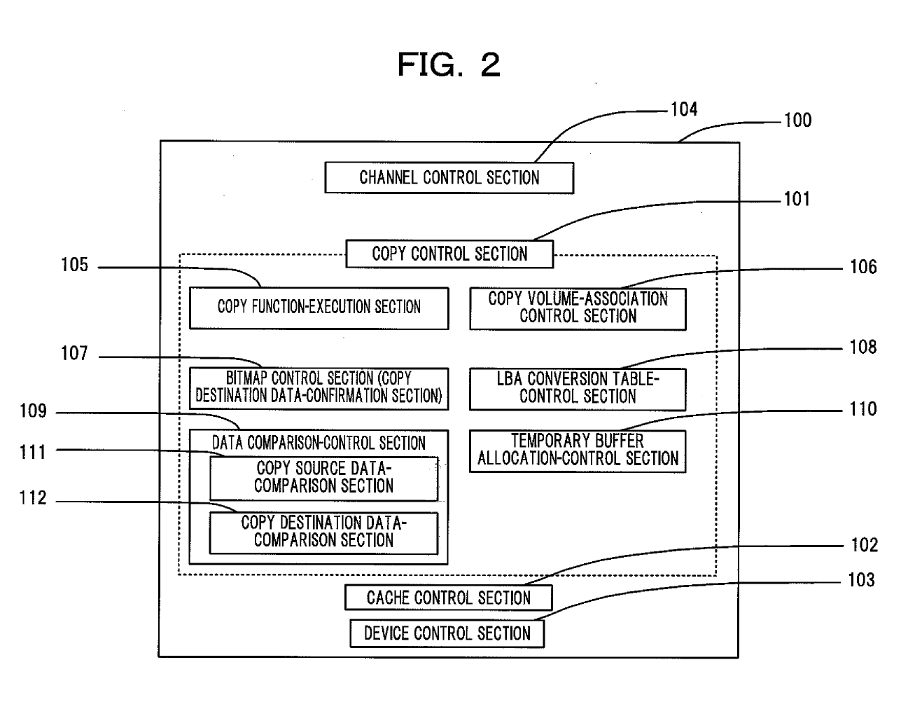

FIG. 2 illustrates an exemplary firmware configuration of the storage control device of which functions are performed based on a program stored in the nonvolatile memory 7. The firmware of the storage control device 100 includes a copy control section 101, a cache control section 102, a device control section 103, and a channel control section 104.

The copy control section 101 includes a copy function-execution section 105, a copy volume association-control section 106, a bitmap control section 107, a logical block addressing (LBA) conversion table-control section 108, a data comparison-control section 109, and a temporary buffer allocation-control section 110. The copy volume association-control section 106 controls association of the copy source volume with the copy destination volume at the SnapOPC execution time.

The bitmap control section 107 updates and refers to bitmap data which is management table data provided to associate the storage area of the copy source volume with that of the copy destination volume. The bitmap control section 107 confirms whether or not data is written into an area of the copy destination volume provided to store data transmitted from the host computer 1. The bitmap control section 107 updates and refers to a logical bitmap data illustrating how the data of a target area of the copy source volume is copied to the copy destination volume and a physical bitmap data illustrating how the physical area of the copy destination volume is used. LBA conversion table data is conversion table data provided to associate logical LBA data illustrating a position where the data of a logical area exists with physical LBA data illustrating a position where the data of the physical area exists. The management table data will be described later with reference to the attached drawing.

The data comparison-control section 109 includes a copy source data-comparison section 111 and a copy destination data-comparison section 112. The copy source data-comparison section 111 compares the data transmitted from the host computer 1 to data that had already been written into the area of the copy destination volume storing the data transmitted from the host computer 1, where the data transmitted from the host computer 1 is written into the area. The copy destination data-comparison section 112 compares the above-described data to the data transmitted from the host computer 1 based on a determination that there is data written into a target area of the copy destination volume, the determination being made by the bitmap control section 107.

Upon receiving data of a request for a buffer, the temporary buffer allocation-control section 110 allocates a temporary buffer onto the cache memory 9. An area of the cache memory 9 and/or the volatile memory 8 provided in the controller module 5 is used as the buffer area.

Hereinafter, a SnapOPC operation and a method of copying data after a SnapOPC instruction is transmitted, where the SnapOPC operation and the copying method are performed in the above-described system, will be described. The term “SnapOPC” denotes a method of making a backup copy of only un-updated data that had been obtained in an area that was subjected to updating through data writing or the like of data of the copy source volume at the backup execution time.

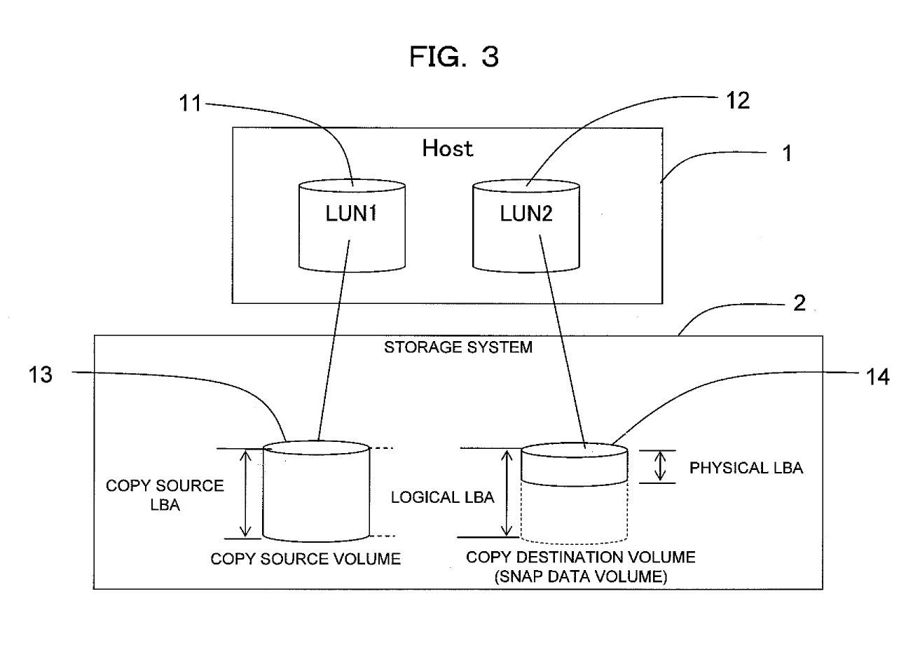

FIG. 3 illustrates the host computer 1 and the storage system 2. Volumes recognized by the host computer 1 include a logical storage capacity 11 of a logical unit number (LUN) 1 and a logical storage capacity 12 of a LUN 2. The physical storage capacity of the copy source volume 13 functioning as a storage device provided in the storage system 2 is equivalent to the logical storage capacity 11 of the LUN 1. The physical capacity of a Snap Data Volume (SDV) provided as a copy destination volume 14 is smaller than the logical capacity of the LUN 2.

Here, when a SnapOPC instruction to perform the SnapOPC is transmitted from the user to the storage control device configured to execute the SnapOPC, the copy volume-association control section 106 associates data of the time when the SnapOPC instruction is received and/or the file generation (the session information) with a storage area storing data of a snapshot of the copy source volume, the snapshot being obtained at the time when the SnapOPC instruction is received, and generates the management table data. At that time, no data is stored in the copy destination volume. The term “snapshot” denotes a set of files and directories that existed in storage at a certain moment in the past and recorded data of the set.

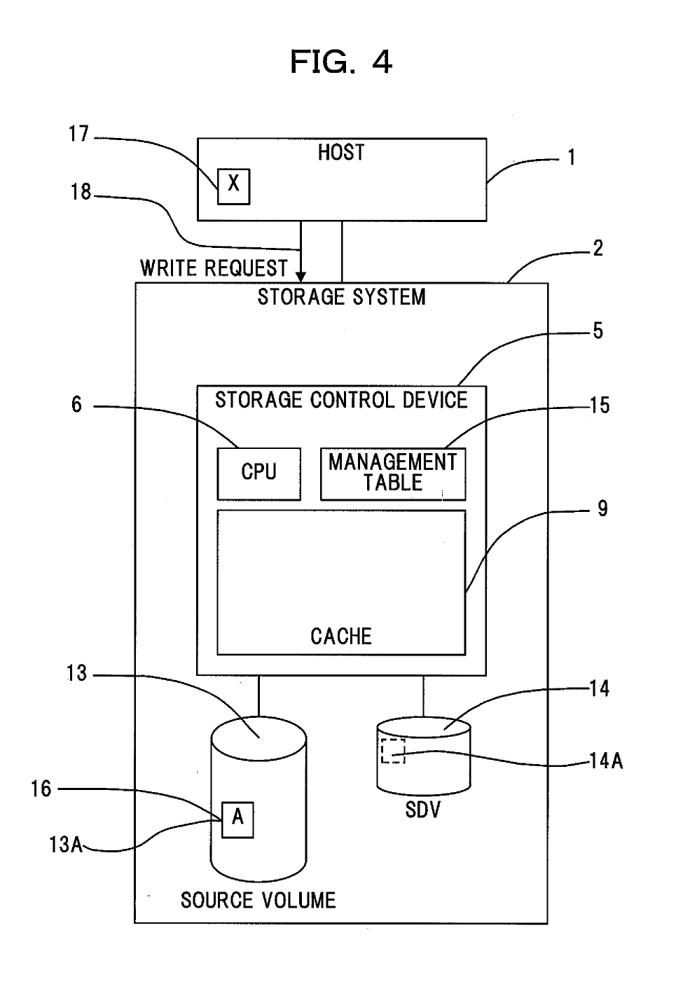

Next, a copying method performed during data write processing will be described. FIG. 4 is a conceptual diagram illustrating a write request transmitted from the host computer 1 to the storage control device 5 after the SnapOPC instruction is transmitted. In the storage system 2 connected to the host computer 1, the copy source volume 13 and the SDV provided as the copy destination volume 14 are connected to the storage control device 5. As described above, the storage control device 5 includes the CPU 6, the management table data 15, and the cache memory 9. Data A16 is stored in a specified storage area 13A of the copy source volume 13.

In the following example, the host computer 1 transmits a write request 18 to the storage control device 5 to write data X17 in the storage area 13A storing data A16 of the copy source volume 13. When the above-described write request 18 is transmitted from the host computer 1 to the storage control device 5, the bitmap control section 107 refers to the management table data 15 to confirm whether or not data had already been written into the storage area 14A of the copy destination volume 14, where the storage area 14A corresponds to the storage area 13A. When the bitmap control section (copy destination data-confirmation section) 107 refers to the bitmap data and confirms that no data had been written into the corresponding area 14A of the copy destination volume 14, the temporary buffer allocation-control section 110 allocates a temporary buffer onto the cache memory 9 and the copy function-execution section 105 stores data X18 transmitted from the host computer 1 in the temporary buffer.

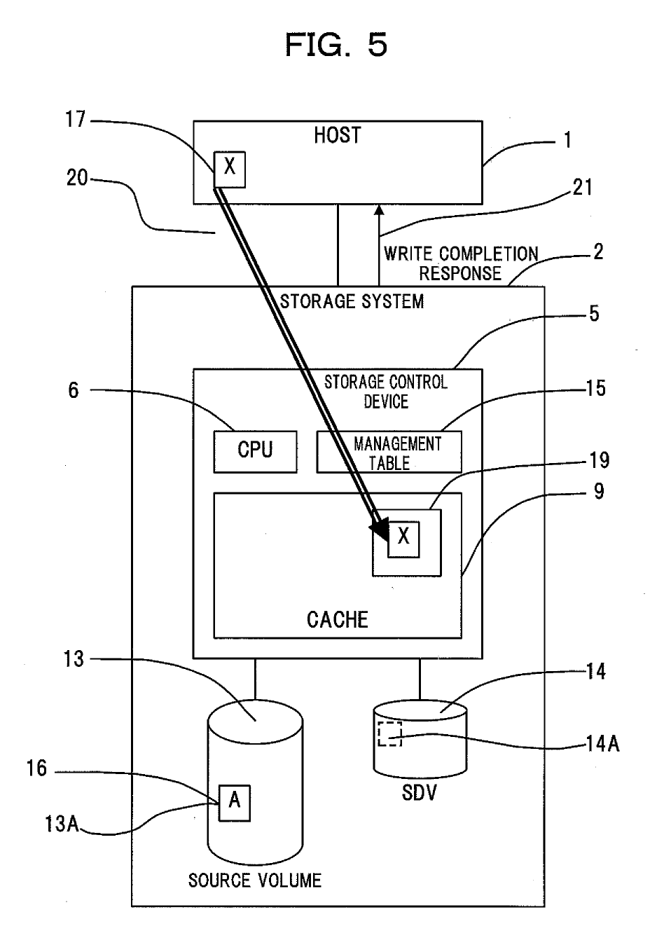

FIG. 5 illustrates how data is written into a temporary buffer 19 and how response data is transmitted to the host computer 1. The temporary buffer allocation-control section 110 allocates a temporary buffer onto the cache memory 9. When the copy function-execution section 105 stores the data X17 in the temporary buffer 19 (indicated by reference numeral 20), the storage control device 5 transmits response data (21) to the host computer 1 via the channel adapter 4 to inform the host computer 1 that the write request is completed.

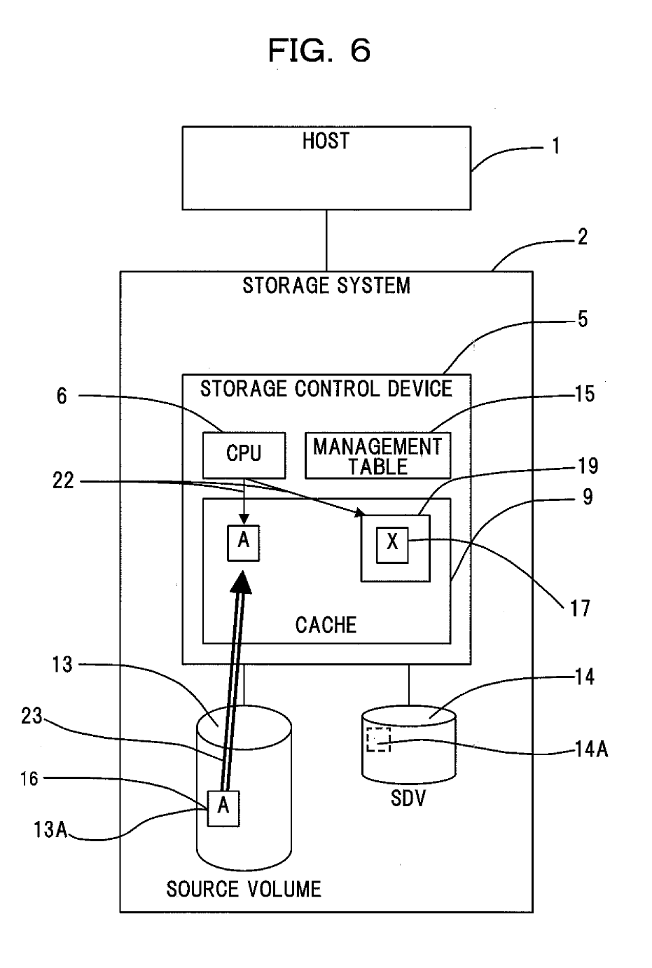

FIG. 6 illustrates an exemplary conceptual diagram illustrating a comparison of the written data and the data of the copy source volume 13. After the write request completion-response data 21 is transmitted, the copy source data-comparison section 111 compares the data A16 of the copy source volume 13, the data A16 being stored in the corresponding storage area 13A, to the data X17 for which the write request is issued. The copy function execution section 105 reads and stores the data A16 of the copy source volume 13 in the cache memory 9 (indicated by reference numeral 23). After the data reading (indicated by reference numeral 23) is completed, the copy source data-comparison section 111 compares the data A16 read and stored in the cache memory 9 to the data X17 stored in the temporary buffer 19 (indicated by reference numeral 22).

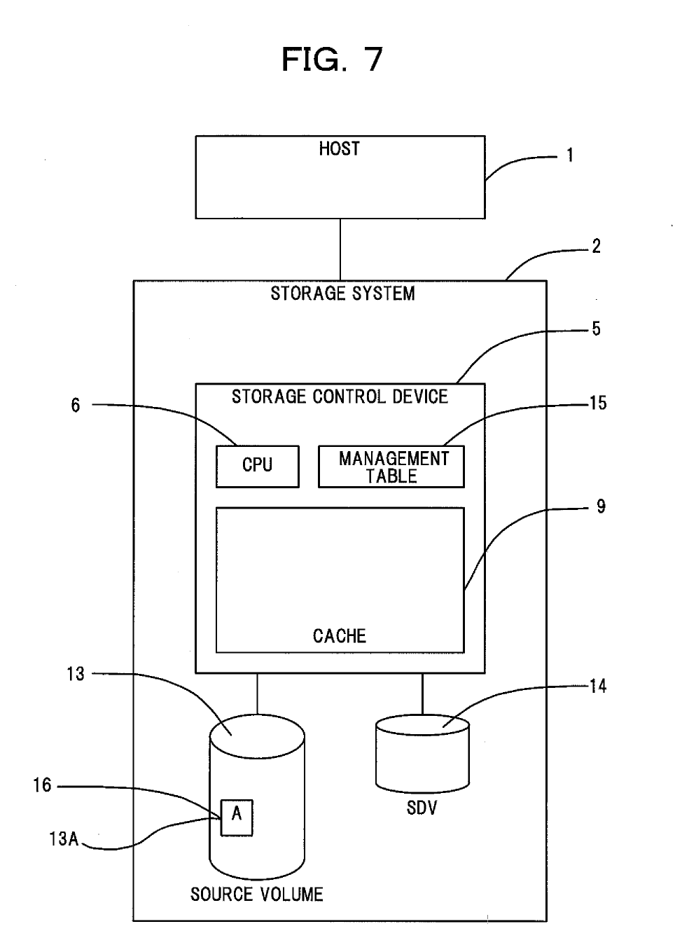

If the data comparison-control section 109 determines that the data A 16 agrees with the data X17, the data is not saved from the copy source volume 13 to the copy destination volume 14 and the temporary buffer 19 is released. FIG. 7 is a conceptual diagram illustrating that the processing is terminated when the data A16 agrees with the data X17. The data A16 is left stored in the corresponding area 13A of the copy source volume 13 and no data is stored in the corresponding area 14A of the copy destination volume 14.

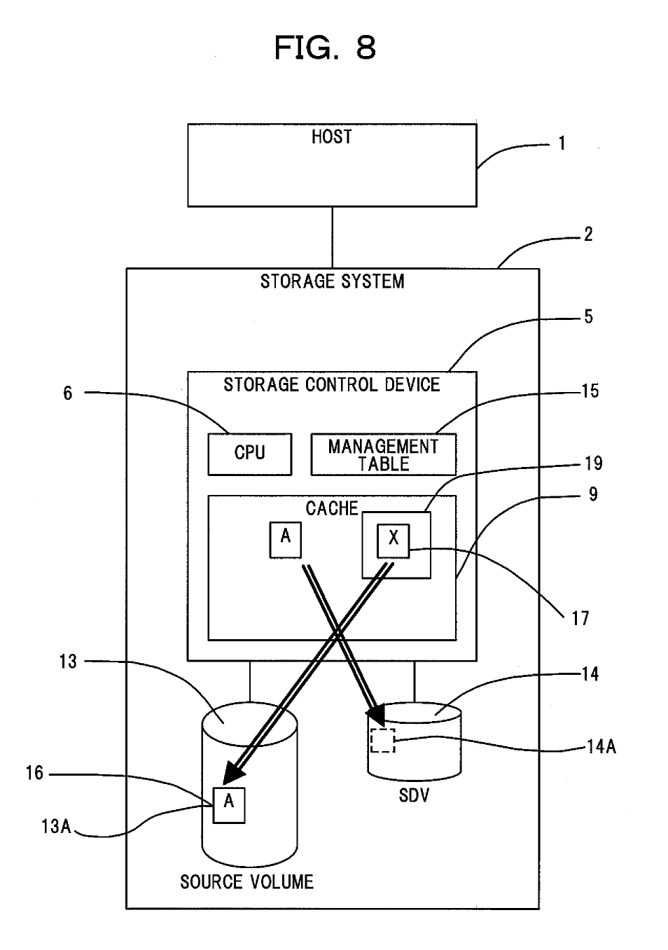

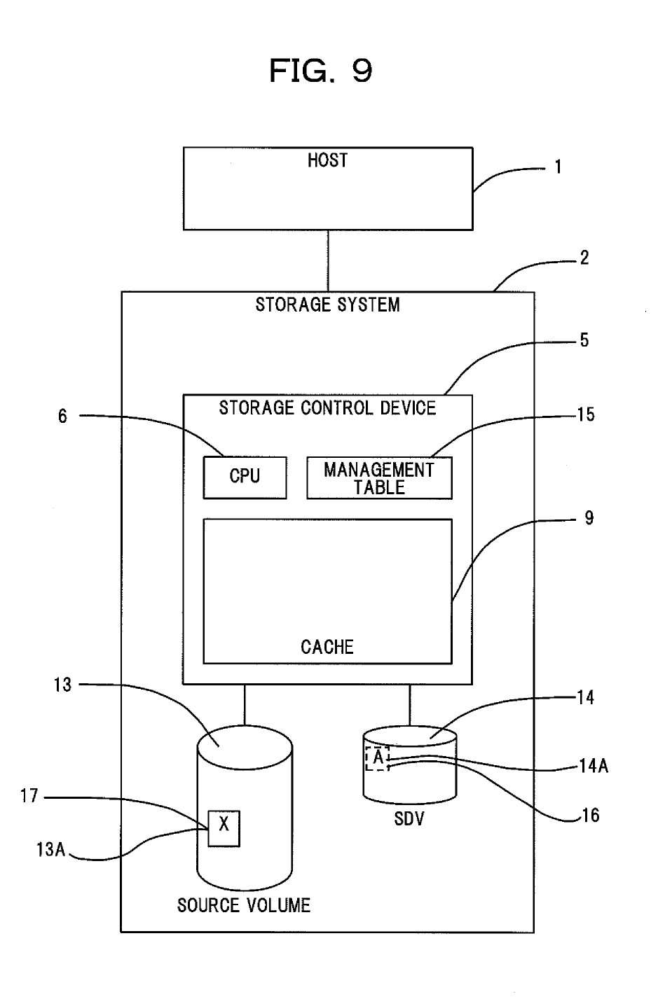

FIG. 8 illustrates an exemplary conceptual diagram illustrating how written data is copied to the copy destination volume 14. When the data comparison-control section 109 determines that the data A16 and the data X17 do not agree with each other, the copy function-execution section 105 copies the data A16 stored in the cache memory 9 to the corresponding area 14A of the copy destination volume 14. The data A16 stored in the area 13A of the copy source volume 13 is overwritten with the data X stored in the temporary buffer. FIG. 9 is a conceptual diagram illustrating that the processing is terminated when compared data items do not agree with each other. The data X is stored in the corresponding area of the copy source volume 13 and the data A16 is stored in the copy destination volume 14.

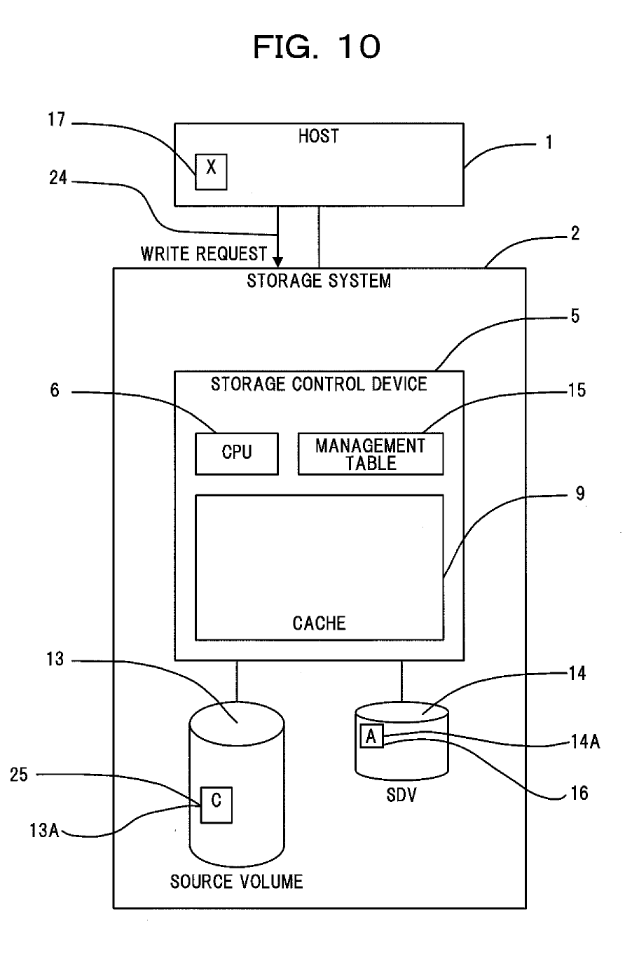

An example where data is stored in the copy destination volume 14 will be described in relation to a copying method performed during write processing. FIG. 10 is a conceptual diagram illustrating the case where a write request 24 is transmitted from the host computer 1 to the storage system 2. Data C25 is stored in the specified area 13A of the copy source volume 13. The data A16 is stored in the specified area 14A of the copy destination volume 14.

The state where data is stored in the copy destination volume 14 is the state where data is written in the target area 13A of the copy source volume 13 on at least one occasion after the Snap OPC instruction is issued. More specifically, the data C25 is transmitted from the host computer 1 and is written into the copy source volume 13 and the data A16 stored in the target area 13A of the copy source volume 13 is copied to the copy destination volume 14.

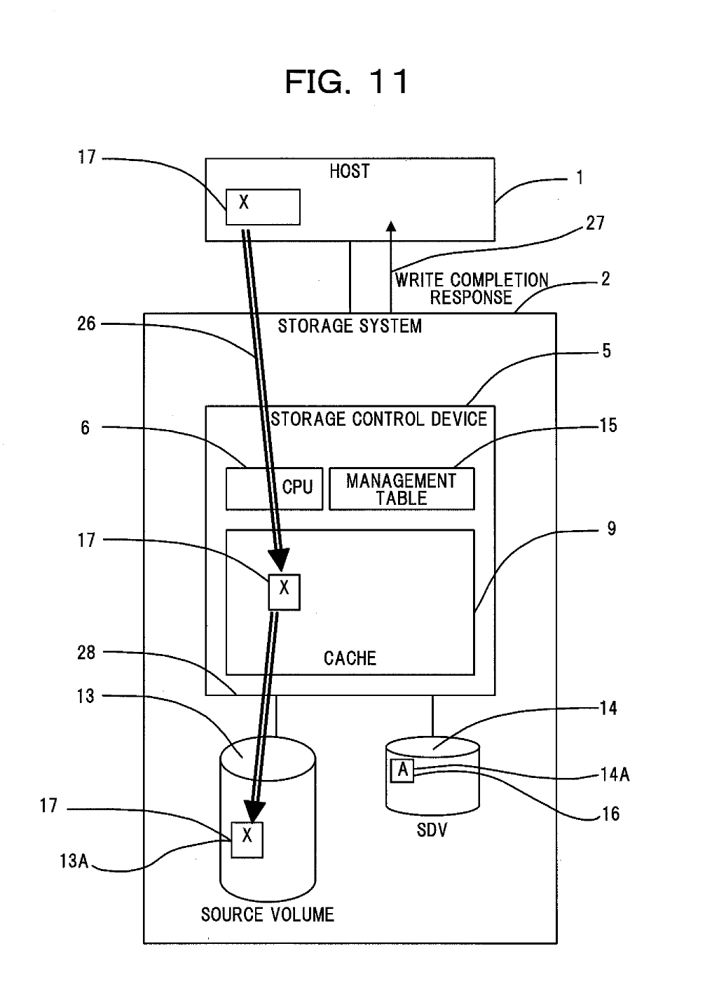

FIG. 11 is a conceptual diagram illustrating how data is written into the cache memory 9 (indicated by reference numeral 26) and how response data 27 is transmitted to the host computer 1. The copy function-execution section 105 stores the data X17 transmitted from the host computer 1 in the cache memory 9 and overwrites the data C25 stored in the specified area 13A of the copy source volume 13 with the data X17 so that the data X17 is copied to the specified area 13A (indicated by reference numeral 28). Since the data A16 which is the data of the target area 13A, the data being obtained when the SnapOPC instruction is issued, is saved in the copy destination volume 14, the data C25 is overwritten with the data X17. After that, the storage control device 5 transmits response data to the host computer 1 to inform the host computer 1 that the write request is completed (indicated by reference numeral 27).

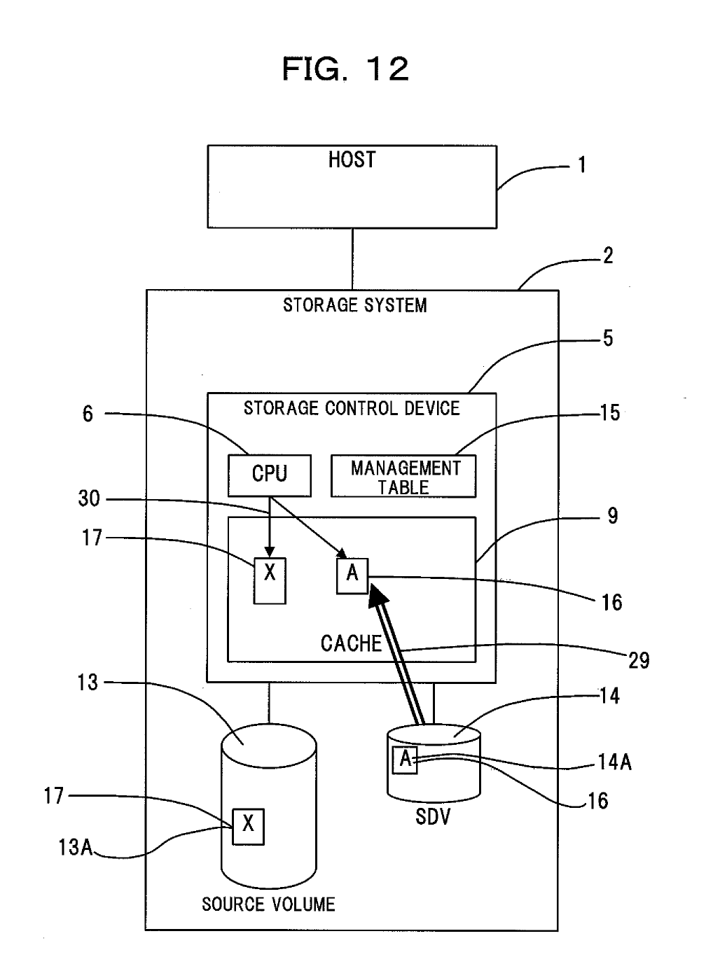

FIG. 12 is a conceptual diagram illustrating a comparison of written data and the data of the copy destination volume 14. The data A16 stored in the corresponding storage area 14A of the copy destination volume 14 is read and stored in the cache memory 9 (indicated by reference numeral 29). The data comparison-control section 109 compares the data X17 and the data A16 to each other, the data X17 and the data A16 being stored in the cache memory 9, and confirms whether or not the data X17 and the data A16 agree with each other.

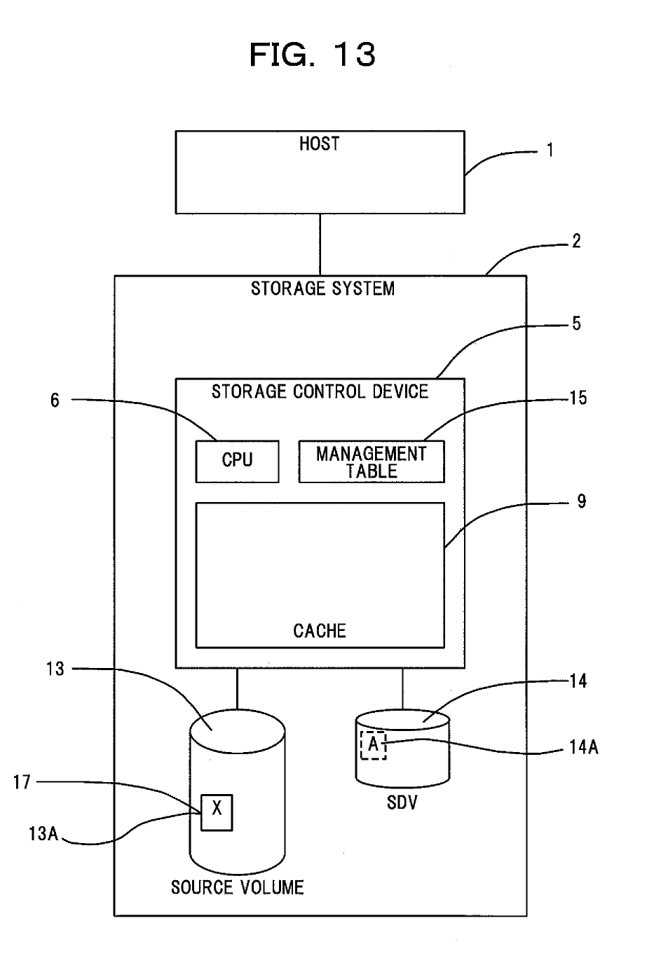

FIG. 13 is a conceptual diagram illustrating that an unallocated area is determined and the processing is terminated when the data X17 and the data A16 are compared and agree with each other. If the data X17 and the data A16 that are compared to each other through the data comparison-control section 109 agree with each other, the bitmap control section 107 updates the management table data 15 and sets the area storing the data A16 of the copy destination volume 14 to an unallocated state to make the above-described area writable.

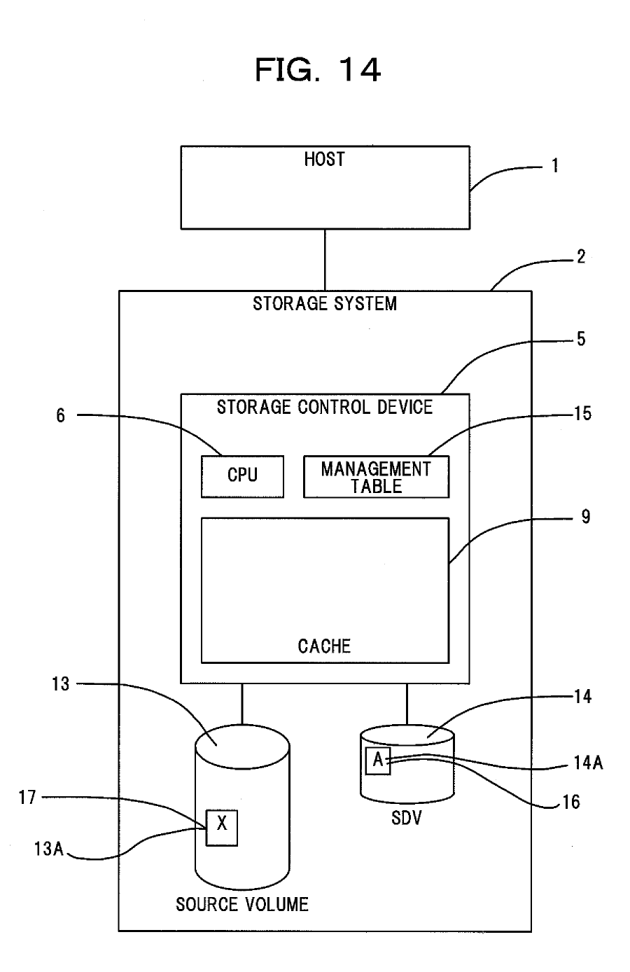

FIG. 14 is a conceptual diagram illustrating that the processing is terminated when the data X17 and the data A16 that are compared to each other do not agree with each other. When the data X17 and the data A16 that are compared to each other do not agree with each other, the data X17 is stored in the target area 13A of the copy source volume 13. The data A16 is stored in the target area 14A of the copy destination volume 14.

Accordingly, it becomes possible to make a backup copy by making a data content comparison during the SnapOPC to reduce redundancy of data items that are equivalent to each other and stored in the copy source volume and an allocated storage area respectively.

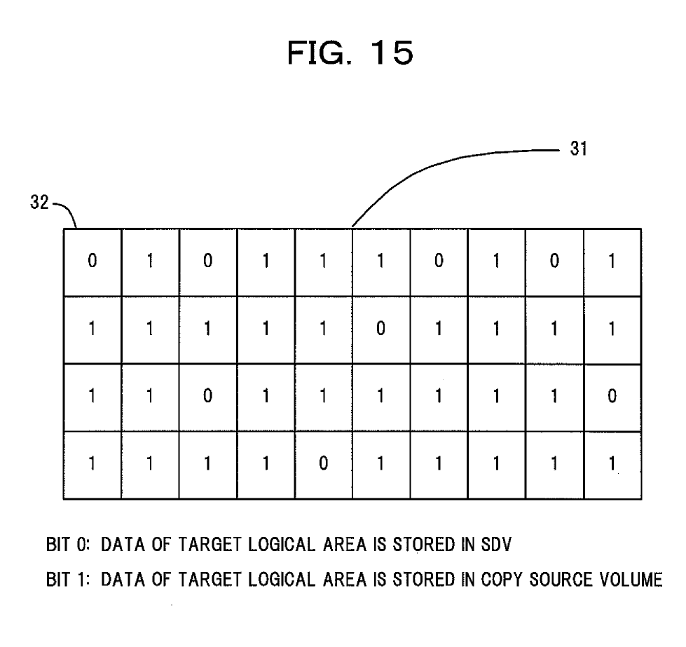

Next, the management table data shown in the above-described conceptual diagrams will be clarified. The following management table data is used in the storage control device of the above-described application. FIG. 15 illustrates logical bitmap data 31 illustrating that the data of a target area of the copy source volume 13 had already been copied to the copy destination volume 14. The data is indicated by the sign “0” and the sign “1” as indicated by a box illustrating the sign “0”, the box being designated by reference numeral 32. The sign “0” indicates that the data of a target logical area is stored in the corresponding storage area of the copy destination volume 14. The sign “1” indicates that the data of the target logical area is stored in the copy source volume.

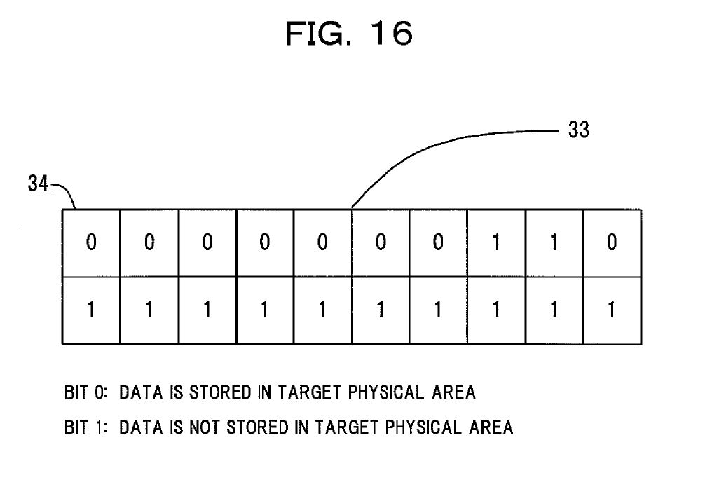

FIG. 16 illustrates physical bitmap data 33 illustrating how the physical area of the copy destination volume is used. A box 34 illustrating the sign “0” indicates that data is stored in the target physical area. A box illustrating the sign “1” indicates that no data is stored in the target physical area.

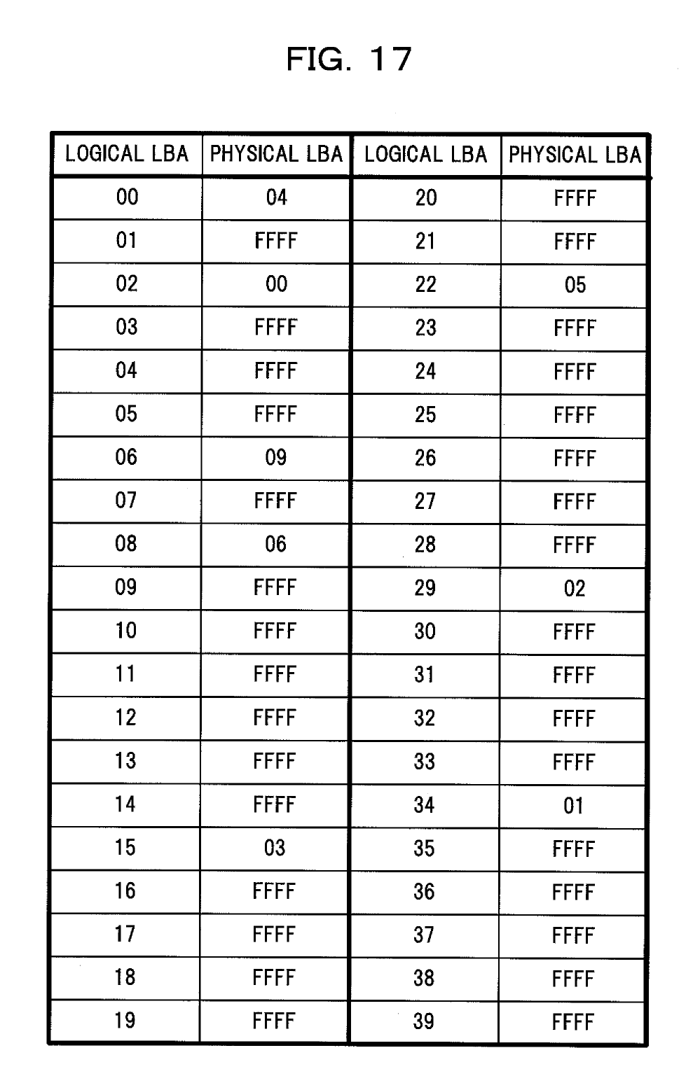

FIG. 17 illustrates LBA conversion table data illustrating the conversion from physical LBA to logical LBA for data stored in the copy destination volume 14. In a part indicating that no data is copied to the copy destination volume 14, 0xFFFF (hexadecimal digit) is shown as an invalid value.

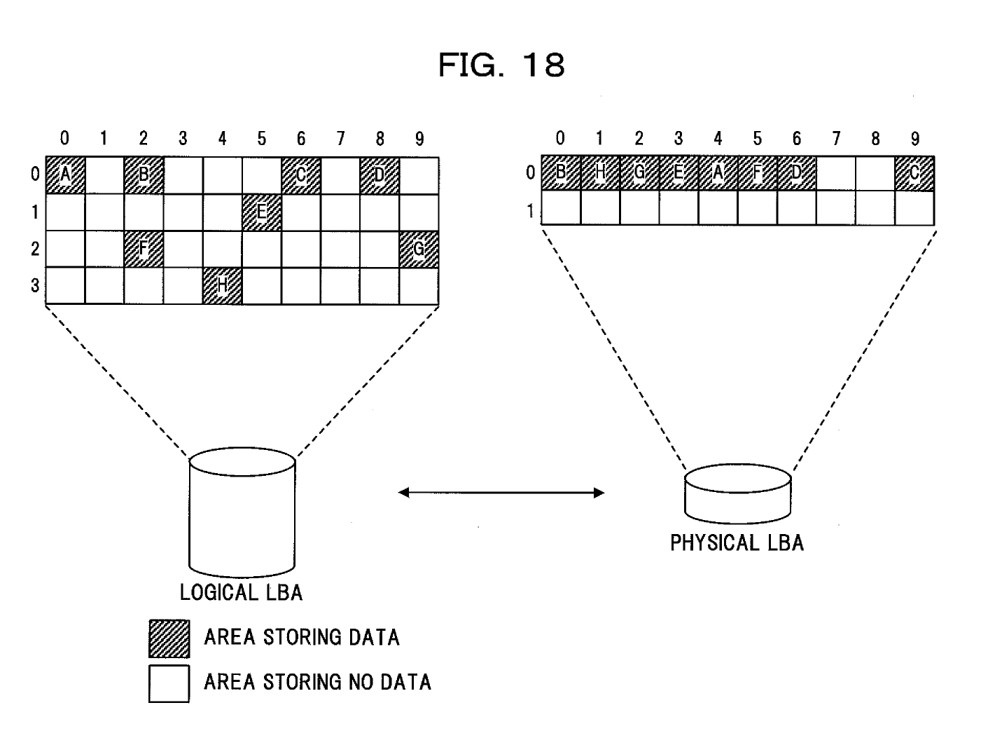

FIG. 18 is a conceptual illustration of the copy destination volume 14 and the management table data. The state of each of the logical area and the physical area of the copy destination volume 14 is indicated by the logical bitmap data 31, the physical bitmap data 33, and the LBA conversion table data. The data stored in the logical LBA 00 of the copy destination volume 14 is stored in the physical LBA 04. 8 kilobytes (KB) of data is stored in a single area.

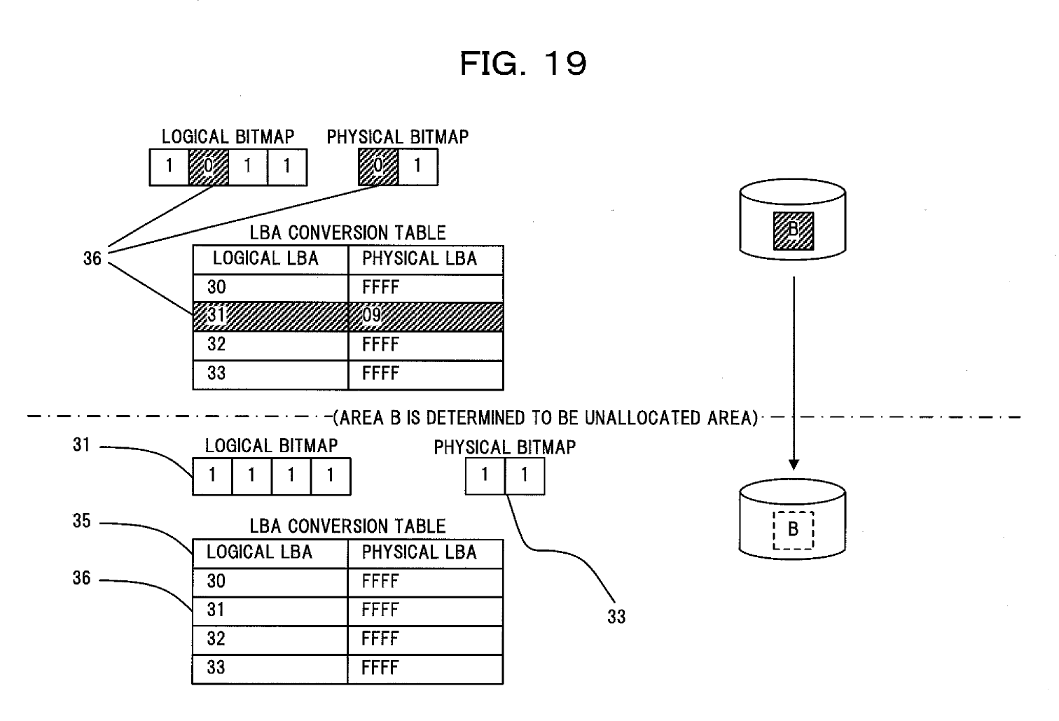

FIG. 19 illustrates the management table data in transition. The logical bitmap data 31, the physical bitmap data 33, and the LBA conversion table data 35 indicate a change point specified when a storage area B is set to the unallocated state. For setting an area storing data B to the unallocated state, data indicated by the sign “0”, the data stored in the corresponding location 36 of each of the logical bitmap data and the physical bitmap data, is converted to data indicated by the sign “1” and data indicated by the sign “09” of the LBA conversion table data 35 is converted into data FFFF so that the area becomes writable. Accordingly, if data is magnetically stored in the storage in reality, the unallocated state occurs in the storage control device, which saves the trouble of physically deleting data and makes it possible to use the data area with efficiency.

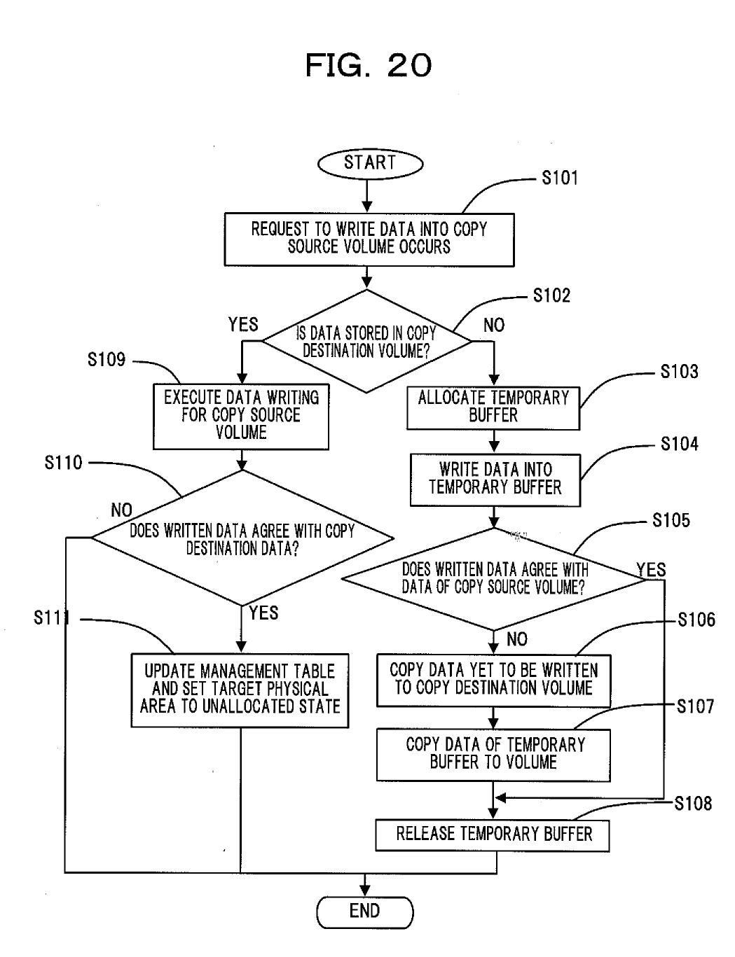

FIG. 20 is a flowchart illustrating exemplary update processing performed through the storage control device.

Upon receiving a request to write data into the copy source volume 13, the request being transmitted from the host computer 1 (step S101), the storage control device confirms whether or not data is written into the corresponding logical storage area of the copy destination volume 14 through the bitmap control section 107 (step S102), as shown in FIG. 20.

It is confirmed whether or not the data is written into a storage area of the copy destination volume 14, the storage area corresponding to the write request, based on the logical bitmap data which is the management table data. If data indicated by the sign “0” is stored in the corresponding position specified on the logical bitmap data, the data of a target logical area is written into the copy destination volume 14. If data indicated by the sign “1” is stored in the corresponding position specified on the logical bitmap data, the data of the target logical area is not written into the copy destination volume 14, but the copy source volume 13.

If it is determined that the data is not written into the logical storage area of the copy destination volume 14, the logical storage area corresponding to the write request, through the copy destination data-confirmation section 107 (when the answer is NO at step S102), the temporary buffer allocation-control section 110 allocates a temporary buffer onto the cache memory 9 (step S103). Then, data transmitted from the host computer 1 is stored in the allocated temporary buffer (step S104).

After the data transmitted from the host computer 1 is stored in the temporary buffer, the data comparison-control section 109 compares the data of the copy destination volume, the data being stored in the corresponding area, to the data for which the write request is issued, the data being stored in the temporary buffer. First, the data of the copy source volume 13 is read and stored in the cache memory 9, and the data comparison-control section 109 compares the data stored in the cache memory 9 to the data stored in the temporary buffer (step S105). If it is determined that the data stored in the cache memory 9 agrees with the data stored in the temporary buffer at that time (when the answer is YES at step S105), the data is not saved from the copy source volume 13 to the copy destination volume 14 and the temporary buffer storing the data is released (step S108), and the processing is terminated.

If it is determined that the data stored in the cache memory 9 does not agree with the data stored in the temporary buffer at that time (when the answer is NO at step S105), the data stored in the cache memory 9 is written into the copy destination volume 14 (step S106).

The data stored in the temporary buffer is written into the corresponding storage area of the copy source volume 13 (step S107). The temporary buffer storing the data is released (step S108) and the processing is terminated.

If it is determined that the data is written into the logical storage area of the copy destination volume 14, the logical storage area corresponding to the write request, through the copy destination data-confirmation section 107 (when the answer is YES at step S102), the data item transmitted from the host computer 1 is stored in the cache memory 9 and the corresponding area of the copy source volume 13 is overwritten with the data item (step S109). The data item stored in the corresponding storage area of the copy destination volume 14 is read and stored in the cache memory 9, and the data comparison-control section 109 compares the data items that are stored in the cache memory 9 to each other (step S110).

If the data items that are compared to each other agree with each other (when the answer is YES at step S110), the bitmap control section 107 updates the management table data and determines the area where the data of the copy destination volume 14 is stored to be an unallocated area (step S111), and the processing is terminated. If the data items that are compared to each other do not agree with each other (when the answer is NO at step S110), the processing is terminated as it is.

Accordingly, the storage control device disclosed in this application allows for omitting an unnecessary data copying operation. The physical capacity of the SDV provided as the copy destination volume 14 is smaller than the logical capacity. Therefore, when data of which capacity is larger than the physical capacity of the SDV is updated for the copy source volume 13, it becomes difficult to save the data and the snapshot is lost. However, it becomes possible to reduce the frequency of occurrence of the above-described phenomenon through the disclosed methods. Since the storage area can be used with efficiency, the reliability of the storage system is increased.

### Second Embodiment

### Method of Checking Data Through Internal Data Comparison Section

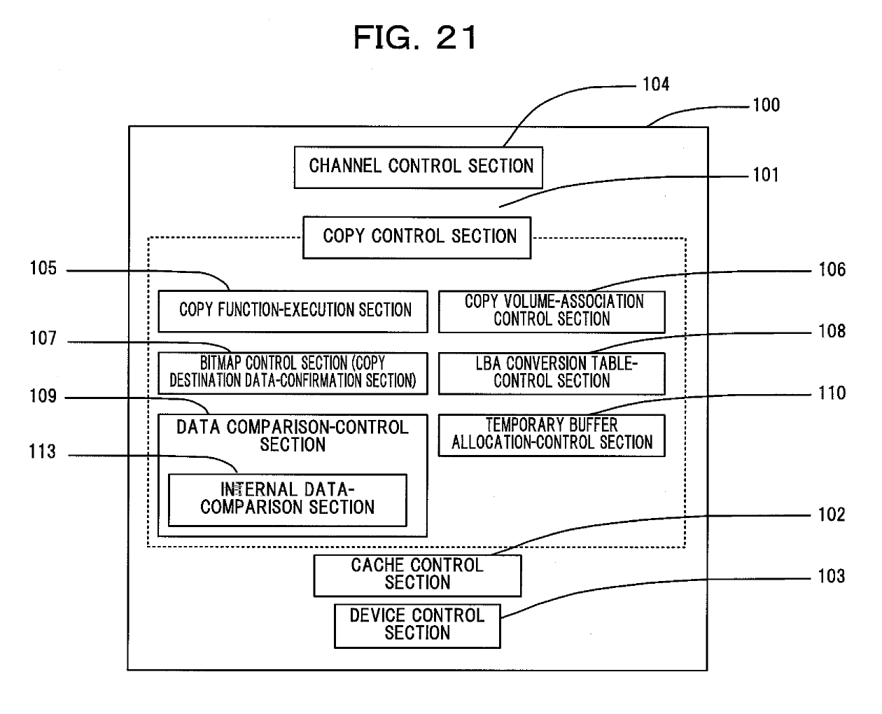

An example case where a copy operation is controlled through an internal data comparison section will be described as a second embodiment of the present invention. FIG. 21 illustrates the firmware configuration of a storage control device according to the second embodiment. The data comparison-control section 109 includes an internal data comparison section 113 configured to compare data stored in a copy source volume to data stored in the position corresponding to the data, the position specified in a copy destination volume.

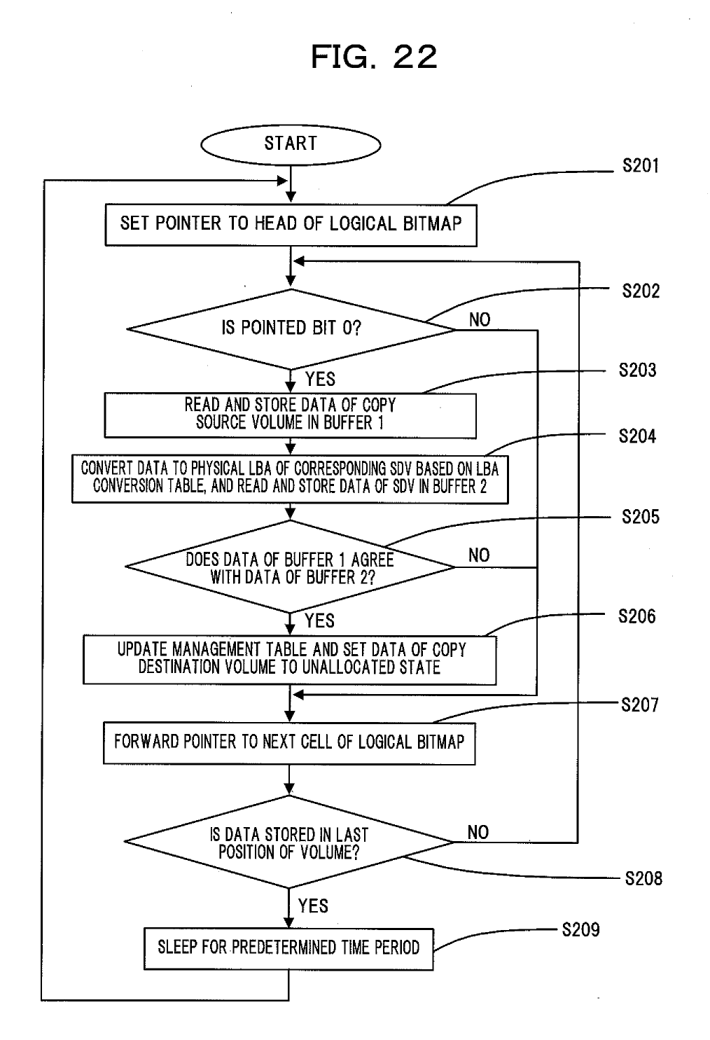

The above-described configuration will be described with reference to a flowchart of FIG. 22. Although the same processing as that of the known SnapOPC is performed at the data writing time, data stored in the copy destination volume is read through the internal data-comparison section 113 on a regular basis, data stored in the logical area of the corresponding copy source volume is read, and the copy source data and the copy destination data are compared to each other. If the copy source data and the copy destination data agree with each other, table data provided to manage an SDV is updated so that the data corresponding to the above-described logical area is removed, and a target area is set to the unallocated state so that the target area becomes allocatable from then on.

The internal data comparison section 113 controls the copy operation so that a pointer configured to indicate an appropriate location during a search is set to the head of logical bitmap data (step S201). The logical bitmap data for pointing is checked to determine whether or not a bit is 0 (step 5202). If the bit is 1 (when the answer is NO at step S202), the pointer is forwarded to the next cell of the logical bitmap data (step S207). If the bit of the next cell is 0 (when the answer is YES at step S202), the temporary buffer allocation-control section 110 allocates buffers 1 and 2 onto the cache memory 9. The device control section 103 reads and stores the data of the copy source volume into the buffer 1 (step S203).

The above-described data is converted into the physical LBA of the corresponding copy destination volume based on the LBA conversion table data and the data of the copy destination volume is read and stored in the buffer 2 (step S204). It is determined whether or not the data of the buffer 1 agrees with that of the buffer 2 (step S205).

When the data of the buffer 1 agrees with that of the buffer 2 (when the answer is YES at step S205), the management table data is updated at step S206 and the data of the copy destination volume is set to the unallocated state (step S206).

When the data of the buffer 1 does not agree with that of the buffer 2 (when the answer is NO at step S205), the pointer is forwarded to the next cell of the logical bitmap data (step S207). It is determined whether or not the data is stored in the last position of the volume at step S208. If the data is stored in the last position of the volume (when the answer is YES at step S208), and if the data is not stored in the last position of the volume (when the answer is NO at step S208), the internal data comparison section 113 enters a sleep state for a predetermined time period. After the predetermined time period elapses, the pointer is set to the head of the logical bitmap data through schedule processing and the above-described flow is performed again.

During each copy operation, the internal data comparison section 113 checks the internal data instead of checking redundant data so that the storage area can be used with efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. A storage control device that copies copy source data stored in a copy source volume to a copy destination volume, the storage control device comprising:
a copy source data-comparison section configured to compare data transmitted from a host computer to data written into an area specified in the copy source volume storing the transmitted data; and
a copy function-execution section configured to avoid writing the transmitted data into the copy source volume based on a determination that the data transmitted from the host computer and the data written into the area of the copy destination volume storing the transmitted data that are compared to each other through the copy source data-comparison section agree with each other.

2. The storage control device according to claim 1, wherein a snapshot indicating the copy source data obtained at time when a backup copy of the copy source data stored in the copy source volume is stored in the copy destination volume is generated.

3. The storage control device according to claim 1, further comprising a copy destination data-confirmation section configured to confirm whether or not there is data written into an area of the copy destination volume storing the data transmitted from the host computer.

4. The storage control device according to claim 1, further comprising management table data provided to associate a storage area of the copy source volume with a storage area of the copy destination volume.

5. The storage control device according to claim 4, further comprising:
first bitmap data indicating how data of a target area of the copy source volume is copied to the copy destination volume; and
second bitmap data indicating how a physical area of the copy destination volume is used.

6. The storage control device according to claims 3, further comprising a copy destination data-comparison section configured to compare the data written into the area of the copy destination volume to the data transmitted from the host computer based on a determination that there is the data written into the area of the copy destination volume, the determination being made through the copy destination data-confirmation section,
wherein the copy destination data-confirmation section changes an allocation state of the area of the copy destination volume of the second bitmap data into a writable state based on a determination that the data written into the area of the copy destination volume and the data transmitted from the host computer that are compared to each other through the copy destination data-comparison section are equivalent to each other.

7. A storage system comprising:
a copy source volume configured to store copy source data;
a copy destination volume configured to store data of a copy of the copy source data;
a storage control section configured to copy the copy source data stored in the copy source volume to the copy destination volume; and
a channel adapter configured to accept an instruction issued from a host computer,
wherein the storage control section includes:
a data comparison-control section provided with a copy source data-comparison section configured to compare the data transmitted from the host computer to data written into an area specified in the copy source volume storing the data transmitted from the host computer; and
a copy function-execution section configured to avoid writing the transmitted data into the copy source volume based on a determination that the data transmitted from the host computer and the data written into the area of the copy destination volume storing the transmitted data that are compared to each other through the copy source data-comparison section agree with each other.

8. A copying method provided to generate a snapshot of copy source data stored in a copy source volume, the snapshot indicating the copy source data obtained when a backup copy of the copy source data is stored in a copy destination volume, at time when the backup copy is made, the copying method comprising:
comparing data transmitted from a host computer to data stored in a position specified in the copy source volume, the position where the transmitted data is stored; and
avoiding writing the transmitted data into the copy source volume when it is determined that the transmitted data is equal to the data stored in the position.

9. The copying method according to claim 8, further comprising a confirming whether or not data is stored into an area specified in the copy source volume, the area storing the data transmitted from the host computer.

10. The copying method according to claim 9, further comprising a comparing data stored in the area of the copy destination volume to the data transmitted from the host computer when it is determined that the data is stored in the area of the copy destination volume,
wherein the area of the copy destination volume is set to a writable state when it is determined that the data stored in the area and the transmitted data that are compared to each other are equivalent to each other.

11. A storage control device generating a snapshot of copy source data stored in a copy source volume, the snapshot indicating the copy source data obtained when the copy source data is copied to a copy destination volume, at time when the copying is performed, the storage control device comprising:
management table data provided to associate a storage area of the copy source volume with a storage area of the copy destination volume;
a search copy function-execution section configured to search an allocated storage area provided on the management table data;
an internal data-comparison section configured to compare data of the allocated area of the copy source volume to data of the allocated area of the copy destination volume; and
a bitmap control section configured to set an appropriate area of the management table data to an unused state when a copy control section determines that the data of the copy source volume is equivalent to the data of the copy destination volume through the internal data-comparison section.

12. The storage control device according to claim 11, wherein the management table data includes first bitmap data indicating how data of a target area of the copy source volume is copied to the copy destination volume; and second bitmap data indicating how a physical area of the copy destination volume is used.

13. A copying method provided to generate a snapshot of copy source data stored in a copy source volume, the snapshot indicating the copy source data obtained when the copy source data is copied to a copy destination volume, at each time when the copying is performed, the copying method comprising:
searching an allocated storage area specified on management table data provided to associate a storage area of the copy source volume with a storage area of the copy destination volume;
comparing data of the allocated area of the copy source volume to data of the allocated area of the copy destination volume; and
setting an appropriate area of the management table data to an unallocated state when a copy control section determines that the data of the copy source volume is equivalent to the data of the copy destination volume at the comparing data.
